(19) United States
(12) Patent Application Publication
(10) Pub. No.: US 2022/0001410 A1
(43) Pub. Date: Jan. 6, 2022

(54) DEVICE COMPRISING ROTARY NOZZLE

(71) Applicant: URAKAMI LLC, Kanagawa (JP)

(72) Inventor: Fukashi URAKAMI, Kanagawa (JP)

(21) Appl. No.: 17/481,388

(22) Filed: Sep. 22, 2021

Related U.S. Application Data
(63) Continuation of application No. PCT/JP2019/048170, filed on Dec. 9, 2019.

(30) Foreign Application Priority Data
Mar. 24, 2019 (JP) 2019-055787

(51) Int. Cl. B05B 13/04; B05B 13/00; B05B 3/06

(52) U.S. Cl. CPC B05B 13/0421; B05B 13/0278; B05B 3/06; B05B 13/005

(57) ABSTRACT

An apparatus includes a moving device movable along the surface of an object, and a rotary nozzle device. A rotary nozzle means comprise a plurality of jet nozzles. Two sets of the rotary nozzle means are arranged in parallel in a direction orthogonal to the moving direction of the moving device, are configured such that a left rotary nozzle means and a right rotary nozzle means perform a rotary motion in association with each other by a rotary transmission means. The jet nozzle of the left rotary nozzle means and the jet nozzle of the right rotary nozzle means are arranged so as to be out of phase with each other.

### CROSS-REFERENCE TO RELATED APPLICATIONS

This is a continuation application of a prior PCT application No. PCT/JP/2019/048170 filed on Dec. 9, 2019.

### TECHNICAL FIELD

The present invention relates to a device comprising a moving device and a rotary nozzle device. More specifically, the present invention relates to a device comprising a moving device movable along an object surface and a rotary nozzle device composed of a rotary nozzle means mounted on the moving device.

### BACKGROUND ART

Conventionally, ultra-high pressure fluids such as water or compressed air mixed with abrasive grains are sprayed on the surface of objects such as oil storage tanks or ship hulls to remove foreign substances such as old paint film or rust that adhere to the surface of the object, or to roughen the surface of the object with the sprayed abrasive grains to prepare the surface for painting, or to clean the surface of the object for non-destructive inspection. Ultra-high pressure waterjet equipment or sandblasting equipment has been put to practical use as equipment to clean the surface of objects for non-destructive inspection.

It can also be used to remove foreign matter such as old paint film or rust adhering to the surface of an object by injecting an ultra-high pressure fluid such as water or compressed air mixed with abrasive grains onto the surface of the object while it is absorbed by the surface of an object such as an oil storage tank or a ship hull by the pressure of an enclosed fluid such as air or water and moves along it. As equipment for roughening the surface of an object by injecting abrasive grains to prepare the surface for painting, or for cleaning the surface of an object for nondestructive inspection.

The apparatus disclosed in Japanese Patent Publication No. 60-26752, Japanese Patent No. 1323843 and U.S. Pat. No. 4,098,378 can be exemplified as a device for removing foreign matter such as an old coating film or rust adhered to the surface of an object or by roughening the surface of the object with the sprayed abrasive grains to adjust the surface of the object or cleaning the surface of the object in order to perform a nondestructive inspection.

The apparatus includes a box body, a plurality of wheels mounted on the box body, a seal connected to the box body and having its free end brought into contact with the surface of the object, and a pressure reducing means for discharging the fluid in the pressure reducing space defined by the box body, the object surface and the seal to the outside.

When the decompression generating means is energized, the fluid in the pressure reducing space is discharged to the outside, the fluid pressure acting on the box body due to the difference in the fluid pressure inside and outside the pressure reducing space is transmitted to the object surface through the wheel, and the device is attracted to the surface of the object by the fluid pressure.

When the wheel is rotationally driven by the driving means such as an electric motor in such an adsorption state, the device moves along the surface of the object by the action of the wheel.

The apparatus is mounted with a nozzle such as an ultra-high pressure water injection nozzle for injecting ultra-high pressure water onto the surface of the object or an abrasive grain injection nozzle for injecting the abrasive grains together with compressed air, and the nozzle is mounted in a state in which the nozzle can perform circular motion so that the substance injected from the nozzle draws a circular locus on the surface of the object.

The following is a specific example of a rotating nozzle in a conventional ultra-high pressure water jet device that performs a circular motion while spraying ultra-high pressure water.

In the rotating nozzle of the conventional ultra-high pressure water jet device, a volume of about 20 liters of water per minute, pressurized to ultra-high pressure of about 2,000 to 2,500 kilograms per square centimeter, is injected through a nozzle with a diameter of 0.1 to 0.5 millimeters. The nozzles are rotated at a high speed of about 1,000 revolutions per minute on a plane parallel to the surface at a distance of 20 to 30 millimeters from the object surface, with a rotational diameter of about 400 millimeters, and the rotating nozzles are moved gradually along the object surface at a speed of about 3 meters per minute to continuously treat the object surface.

In the above device, the ultra-high pressure hose that supplies the nozzle with ultra-high pressure water and the rotating nozzle are connected by a rotating joint.

The reason why the nozzles are rotated at high speed in the above device is because the diameter of the nozzles is very small (0.1 to 0.5 mm) and the processing width is also very small, so if the nozzles are rotated at low speed, the treated surface will be treated as a line only in the area where the center of the nozzle moves, and not as a surface. If the nozzle is rotated at a low speed, the processed surface will be treated as a line only in the area where the center of the nozzle moves, and not as a surface.

The conventional device described above has the following problems to be solved.

In the rotating nozzle of the conventional ultra-high pressure water jet device, the nozzle is moving in a constant velocity circular motion, so the processing capacity increases when the nozzle is located at the left or right end of the nozzle in the direction of the movement of the entire rotating nozzle, and decreases when the nozzle is located at the front or rear end. When the nozzle is located at the left or right end, the processing capacity increases, and when it is located at the front or rear end, it decreases, resulting in uneven processing.

In view of the above problem, the inventor proposed the device described in JP-2001-179143 as a device that can prevent the occurrence of uneven processing compared to conventional devices.

An overview of the above device is given below.

In a device equipped with a rotating nozzle, a moving means is provided to move the nozzle along a circular trajectory along the surface to be sprayed, and the nozzle is made to move in an unequal circular motion. In other words, the motion speed increases when the nozzle is located at the left or right end of the device equipped with the rotating nozzle, and decreases when it is located at the front or rear end. The moving means is equipped with a seal 36 that defines a decompression space in cooperation with the box 2 and the moving surface, and decompression generating means for discharging fluid from the decompression space to decompress the inside of the decompression space, and a carriage that is adsorbed to the moving surface by the pressure of the surrounding fluid and can move along the moving surface. The nozzle performs a circular motion in the depressurized space of the cart.
Patent Reference 1: Japan Examined Patent Application Publication No. S60-26752
Patent Reference 2: Japan Patent Publication No. 1323843
Patent Reference 3: U.S. Patent Publication No. 4,095,378
Patent Reference 4: Japan Published Patent Application No. 2001-179143

### SUMMARY OF THE INVENTION

The above-described conventional apparatus has the following problems. That is, in the apparatus described in Japanese Unexamined Patent Publication No. 2001-179143, since a nozzle for performing unequal speed circular motion is connected to a flywheel having a heavy mass for performing constant velocity circular motion through a motion transmission mechanism for converting constant velocity circular motion into unequal velocity circular motion, the mass of the device becomes heavy.

The present invention has been made in view of the above-mentioned problems, and provides an apparatus which is reduced in weight by abolishing the use of a flywheel having a heavy mass, and an apparatus in which the treatment width is increased by providing two rotary nozzle means.

Further, the nozzle rotating device according to the present invention provides an environment-friendly device capable of sucking and recovering the foreign matter peeled from the injected substance or the surface of the object by the vacuum generating device, thereby eliminating the source of the atmosphere floating substance and preventing environmental pollution by performing the injection of the substance on the object surface in a reduced pressure space moving along the surface of the object.

The apparatus of the present invention is a device comprising a moving device that can move along the surface of an object and a rotating nozzle device comprising rotating nozzle means mounted on the moving device. Details of the configuration of the apparatus of the present invention are as follows.

The rotating nozzle means is equipped with a rotating nozzle means consisting of a left-rotating nozzle means and a right-rotating nozzle means, and the rotating nozzle means is equipped with a plurality of injection nozzles. The rotating nozzles are configured in such a way that the projectiles (which are sprayed from at least two nozzles in a circular motion and strike the surface) draw a circular trajectory on the surface.

The two sets of rotating nozzles are arranged in parallel in a direction perpendicular to the moving direction of the moving unit, and the two sets of rotating nozzles are interlocked by means of a roller chain and sprockets or gears or other conduction means to perform rotating motion.

The jet nozzles of each rotating nozzle means are configured to perform an unequal circular motion.

Specifically, the motion speed increases when each of the spray nozzles is located in the left end region or the right end region toward the moving direction of the moving unit, and

the motion speed is reduced when each of the spray nozzles is located in the forward end region or the backward end region toward the moving direction of the moving unit.

The spray nozzles of the left-rotating nozzle means and the spray nozzles of the right-rotating nozzle means can be arranged so that they are out of phase with each other.

The phase shift between the jet nozzles of the left-rotating nozzle means and the jet nozzles of the right-rotating nozzle means is sufficient if they are configured so that the reaction force of the acceleration of the motion of the left jet nozzle and the reaction force of the acceleration of the motion of the right jet nozzle cancel each other out.

The angle of phase shift between the jet nozzle of the left rotating nozzle means and the jet nozzle of the right rotating nozzle means is preferably more than 50 degrees, but more preferably, it is about 90 degrees.

The jetting nozzle of the left-rotating nozzle means and the jetting nozzle of the right-rotating nozzle means are configured so that when the circular motion of the left jetting nozzle is accelerated, the circular motion of the right jetting nozzle is decelerated.

In addition, when the circular motion of the left jet nozzle is decelerated, the circular motion of the right jet nozzle is accelerated.

In other words, the system is configured so that the reaction force of the acceleration of the motion of the left jet nozzle cancels out the reaction force of the acceleration of the motion of the right jet nozzle.

According to the apparatus provided with the rotary nozzle device according to the present invention, the two rotary nozzle means further includes a non-circular gear mechanism as a motion transmission mechanism for converting each constant velocity circular motion into unequal velocity circular motion.

According to another aspect of the present invention, the apparatus equipped with a rotary nozzle device of the present invention further comprises a moving device,

The moving device is equipped with a box, a seal that defines a decompression space together with the box and the surface, and decompression generating means for discharging fluid from the decompression space and decompressing the inside of the decompression space, so that the moving device is a cart that can be absorbed by the surface and moved along the surface by the pressure of the enclosed fluid,

Thus, the moving device is configured so that the spray nozzles perform a circular motion in the depressurized space of the carriage, and the sprayed material from the spray nozzles shoots onto the surface and draws a circular trajectory on the surface.

The present invention has the following effects.

In the devices equipped with the rotating nozzles, such as conventional ultra-high pressure water jet devices, the nozzles perform a circular motion so that the trajectory of the point at which the ultra-high pressure fluid such as water or the substance such as abrasive grains injected from the nozzles shoots onto the surface draws a circular trajectory.

However, in the devices equipped with the rotating nozzles, such as conventional ultra-high pressure water jet devices, the jetting nozzles have a constant velocity circular motion, so that the processing capacity increases when the nozzles are located at the left end or the right end, and the processing capacity decreases when the nozzles are located at the front end or the rear end.

The problem is that uneven processing occurs due to the phenomenon that the processing capacity increases when the nozzle is located at the left or right end and the processing capacity decreases when the nozzle is located at the front or rear end.

In the present invention, the nozzle is configured to perform unequal velocity circular motion with respect to the velocity of motion in which the nozzle draws a circular trajectory.

More specifically, the apparatus according to the present invention is configured to increase the movement speed when the nozzle is located at the left end or the right end toward the moving direction of the apparatus, and to reduce the movement speed when the nozzle is located at the front end or the rear end toward the moving direction of the apparatus,

Therefore, it is possible to prevent the occurrence of uneven processing and to perform a uniform and efficient surface treatment operation in the present invention.

According to the present invention, by performing the injection of the substance on the object surface in a reduced pressure space moving along the surface of the object, the foreign matter peeled from the injected substance or the surface of the object can be sucked and recovered by the vacuum generation device, so that the generation source of the atmosphere floating substance can be eliminated and environmental pollution can be prevented.

### BRIEF DESCRIPTION OF THE DRAWINGS

FIG. 1 is a plan view showing an embodiment of a device constructed in accordance with the present invention;

FIG. 2 is a lower side view of the apparatus of FIG. 1;

FIG. 3 is a cross-sectional view taken along line A-A of the apparatus of FIG. 1; and

FIG. 4 is a plan view showing the gear motion of a non-circular gear and the circular motion of an injection nozzle.

### DETAILED DESCRIPTIONS OF THE PREFERRED EMBODIMENTS

Embodiments of the apparatus according to the present invention will now be described in detail with reference to the accompanying drawings.

The apparatus according to the present invention may be a device capable of removing foreign matter such as an old coating film or rust adhered to the surface of an object or roughening the surface of the object by jetting a substance such as ultra-high pressure fluid such as water or compressed air mixed with abrasive grains on the surface of the object.

The apparatus according to the present invention may be a device capable of coating an object surface by spraying a coating material or a material such as a plasma-formed metal on the surface of the object.

The apparatus of the present invention may also be an apparatus capable of treating an object surface by spraying various substances onto the surface of the object while adsorbing and moving along the object surface by the pressure of the enclosed fluid such as air or water.

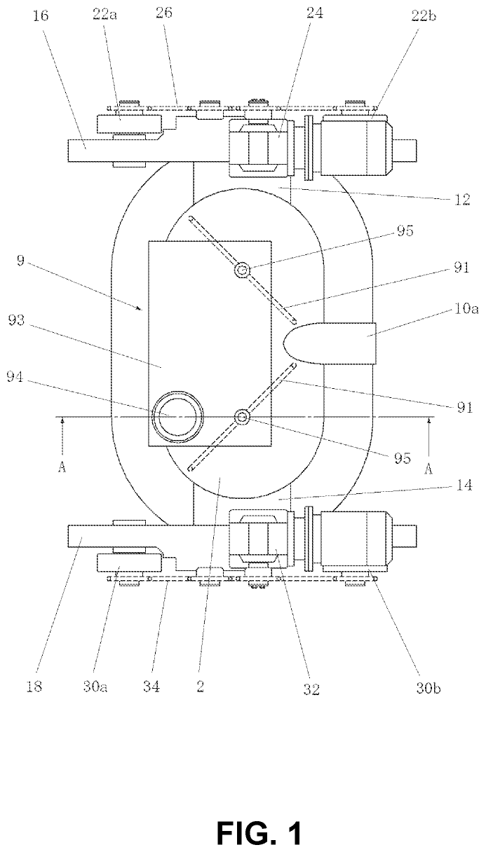

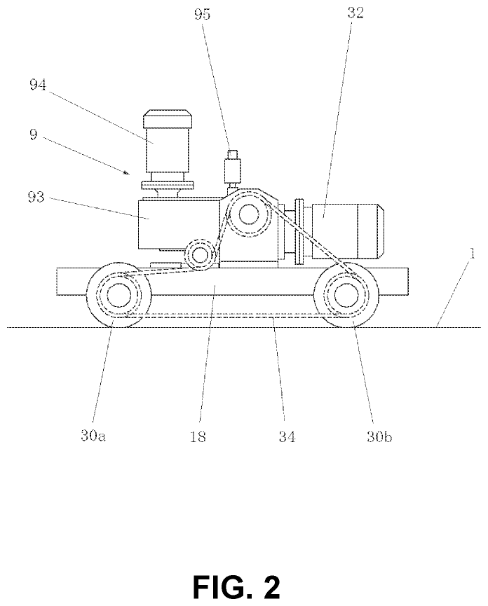

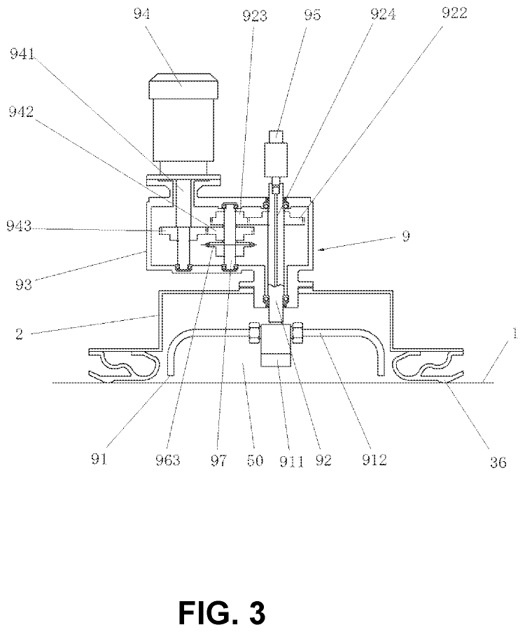

FIG. 1 is a plan view of an apparatus according to the present invention, FIG. 2 is a lower side view of the apparatus according to the present invention shown in FIG. 1, and FIG. 3 is a cross-sectional view of the apparatus according to the present invention shown in FIG. 1.

The apparatus illustrated in FIGS. 1, 2 and 3 comprises a box body 2 formed from a rigid material such as steel, or a semi-rigid material.

As shown in FIG. 3, although the box body 2 is not particularly limited to its shape, in the illustrated embodiment, the box body 2 has the shape of an oblong cylindrical box with an opening on the part facing the object surface 1 on which the apparatus of the present invention moves, and an oblong plate is welded to the outer edge of the opening.

As shown in FIG. 1, support members 12 and 14 projecting outward are fixed to both opposing portions of the side wall of the box body 2, and support frames 16 and 18 are further fixed to the support members 12 and 14.

As shown in FIG. 1, wheels 22a and 22b are rotatably mounted to the support frame 16. The support frame 16 is further provided with an electric motor 24 constituting a traveling drive sources. The electric motor 24 is coupled to wheels 22a and 22b via a transmission means such as a chain 26 and a sprocket to rotationally drive wheels 22a and 22b.

Wheels 30a and 30b are also rotatably mounted on the support frame 18. The support frame 18 is also provided with an electric motor 32 constituting a travel drive source. The electric motor 32 is coupled to wheels 30a and 30b via a transmission means such as a chain 34 and a sprocket to rotationally drive wheels 30a and 30b.

These wheels 22a, 22b, 30a and 30b constitute a traveling means for moving the device according to the present invention along the object surface 1.

These wheels are pressed against the object surface 1 by the surrounding fluid pressure acting on the box body 2 and brought into contact with the object surface 1, as will be described in more detail later.

In the above embodiment, four wheels are used as the traveling means, but it is not limited to the wheels, but the number of wheels is not limited, and three or more wheels may be used, and two or more endless tracks may be used instead of the wheels.

As shown in FIG. 3, a seal 36 is provided in the opening of the box body 2 and attached thereto.

One end of the generally oval and annular seal 36 (FIG. 1) is connected to the oval plate of the box body 2, and the other end is brought into contact with the object surface 1 to define a reduced pressure space 50 with the box body 2 and the object surface 1.

Because the seal 36 is made of a non-breathable and relatively soft material, such as polyurethane, it is elastically deformed by a relatively small force, thereby displacing the end contacting the object surface 1 in the direction of the object surface 1 and away therefrom relative to the box body 2.

The pressure reducing space 50 (FIG. 3) defined by the box body 2, the object surface 1 and the seal 36 is communicated with a decompression generating means (not shown).

As a specific example, a connection pipe part 10a is provided on a side wall of the box body 2, one end part of a suction hose (not shown) is connected to the connection pipe part 10a, and the other end part thereof is connected to a decompression generation means (not shown) via a separator (not shown) such as a bag filter unit.

The decompression generating means (not shown) may eliminate the fluid from the pressure reducing space 50 to reduce the pressure in the pressure reducing space 50. An exhaust pump or an ejector can be used when the apparatus according to the present invention is operated in the atmosphere, and a drain pump can be used when the apparatus according to the present invention is operated in water or under the sea.

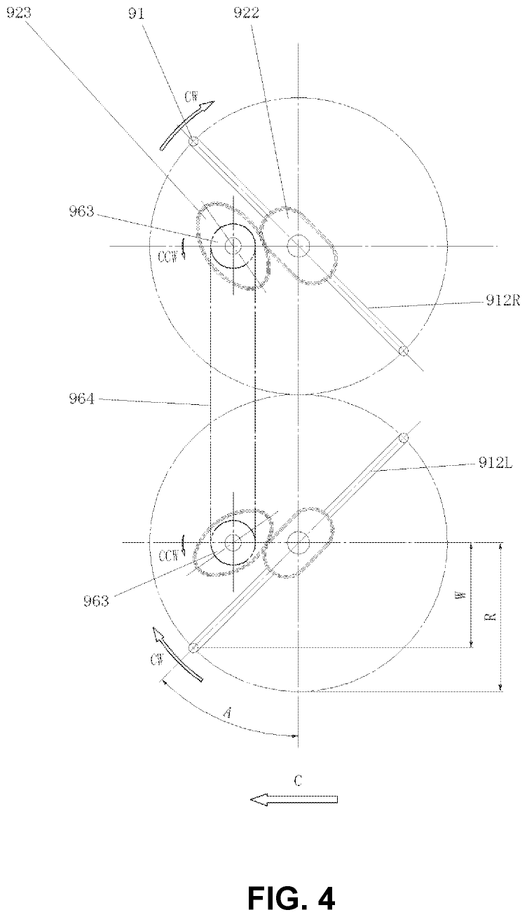

Referring mainly to FIGS. 3 to 4, a gear box 9 is fixed to a bottom surface portion of a flange portion located above the box body 2.

The electric motor 94 is fixed to a flange portion located above the gear box 9 of the flange portion.

The gear box 9 supports the output shaft 941 of the electric motor 94 and the intermediate shaft 97, which is located between the output shaft 941 of the electric motor 94 and the two rotating nozzle shafts 92, with bearings.

A nozzle holder 911 is provided at an end of each rotary nozzle shaft 92 on the object surface side, two nozzle bars 912 are provided in the nozzle holder 911, and an injection nozzle 91 is provided to each of the nozzle bars 912.

The end on the opposite side of the object surface of each rotary nozzle shaft 92 passes through the upper surface of the gear box 9, a rotary joint 95 is screwed to the end, and the rotary joint 95 is connected to an ultra-high pressure water hose (not shown).

The axial part of each rotating nozzle shaft 92 has small holes as a flow path for ultra-high-pressure water, forming a flow path for ultra-high-pressure water from the ultra-high-pressure water hose (not shown), through the rotating joint 95, small holes 924, nozzle holder 911 and nozzle bar 912, to the injection nozzle 91.

A driven side non-circular gear 922 is provided at the top of each rotating nozzle shaft 92, and a primitive side non-circular gear 923, which meshes with the driven side non-circular gear 922, is provided at the top of the intermediate shaft 97.

As illustrated in FIG. 4, the non-circular gear 922 on the driven side has a shape generally close to an oval, and the non-circular gear 923 on the driven side has a shape generally close to a diamond.

A circular gear 942 on the driven side is provided in the center of the intermediate shaft 97, and a circular gear 943 on the prime mover side is provided on the output shaft 941 to mesh with the circular gear 942 on the driven side. A sprocket 963 is provided at the bottom of each intermediate shaft 97, and a roller chain 964 is suspended between the two sets of sprockets 963.

The two sets of nozzle bars 912 and the two sets of non-circular gear means are arranged out of phase.

The two sets of nozzle bars 912 and the two sets of non-circular gear means should be arranged out of phase so that the output shaft 941 and intermediate shaft 97 can perform constant velocity circular motion and the rotating nozzle shaft 92 can perform non-constant velocity circular motion, preferably about 90 degrees out of phase with each other.

The two spray nozzles 91, which are attached to the rotating nozzle shaft 92 via the nozzle holder 911 and nozzle bar 912, also perform an unequal circular motion.

The operation of the apparatus described above will be described.

When a reduced pressure generating means (not shown) is actuated, the action of the reduced pressure generating means causes the fluid in the decompression space 50 (eg, water when used in the atmosphere) to be discharged to the outside through a suction hose (not shown), thereby reducing the pressure in the reduced pressure space 50 as desired.

Because the seal 36 is formed of a relatively soft material, the surrounding fluid pressure acting on the box body 2 due to the fluid pressure difference between the inside and outside of the pressure reducing space 50 is transmitted from the substantially box body 2 to the object surface 1 through the support frames 16 and 18 and the wheels 22a, 22b, 30a and 30b, whereby the device is attracted to the object surface 1.

The surrounding fluid pressure acting on the seal 36 due to the fluid pressure difference between the inside and outside of the pressure reducing space 50 acts to bias the seal 36 toward the object surface 1 and bring the end into contact with the object surface 1.

As shown in FIG. 1, when the electric motors 24 and 32 are activated to drive the wheels 22a and 22b and the wheels 30a and 30b in the same direction, the device will go straight (forward or backward) along the object surface 1, and when the wheels 22a and 22b and the wheels 30a and 30b are driven in the opposite direction, the device will rotate around its central axis (left or right rotation) and is directed in the desired direction.

The operation and the effect of the nozzle 91 for performing unequal speed circular motion will be described.

Conventional rotating nozzles of ultra-high pressure water jet systems have a problem of uneven processing due to the phenomenon that the processing capacity increases when the nozzle is located at the left or right end of the nozzle in the direction of movement of the entire rotating nozzle, and decreases when the nozzle is located at the front or rear end.

In the device of the embodiment of the present invention, which is equipped with a nozzle 91 that performs non-constant circular motion to eliminate the above-mentioned uneven processing, when the electric motor 94 is operated to drive the output shaft 941 in rotation, the intermediate shaft 97 on the driven side is driven in rotation to perform constant velocity circular motion due to the meshing of the gear 943 on the output shaft 941 with the gear 942 on the intermediate shaft 97.

Similarly, due to the meshing of the gear 923 on the rotationally driven intermediate shaft 97 with the circular gear 922 on the rotating nozzle shaft 92, the rotating nozzle shaft 92 on the driven side is also rotationally driven, but the rotating nozzle shaft 92 performs an unequal circular motion due to the action of the non-circular gears 922 and 923.

An operation of non-circular gears 922 and 923 will be described below with reference to FIG. 4

In FIG. 4, the arrow C represents the direction of movement of the apparatus according to the present invention, A represents the angle formed by the nozzle bar 912 and the nozzle 91 in parallel to the surface on which the apparatus of the present invention moves, R represents the radius of rotation of the nozzle 91, and W represents the distance between the center line in which the rotary nozzle shaft of the apparatus of the present invention moves and the nozzle 91.

The acceleration of the injection nozzle 91 increases rapidly in the vicinity of 0 degrees (360 degrees) and 180 degrees, and therefore, in order to perform unequal speed circular motion by the injection nozzle 91, reaction force is required to overcome the inertia force of the injection nozzle 91 and the nozzle bar 912 to prevent the change of the acceleration.

The apparatus according to one embodiment of the present invention is provided with a rotary nozzle means, and the rotary nozzle means is composed of a left rotary nozzle means and a right rotary nozzle means. The left rotary nozzle means and the right rotary nozzle means are arranged in parallel in a direction crossing at right angles to the moving direction of the moving device (FIG. 4), and the rotary motion is performed by interlocking with the rotation conductive means by the sprocket 963 and the roller chain 964.

The rotation direction of the sprocket 963 is indicated by CCW, and the rotation direction of the nozzle bar 912L of the left rotary nozzle means and the nozzle bar 912R of the right rotary nozzle means is indicated by CW. The velocity of motion in which the injection nozzle draws a circular trajectory is provided, the injection nozzles of each of the rotating nozzle means are configured to perform unequal velocity circular motion, that is, when each injection nozzle is located in the left end region or the right end region toward the moving direction of the moving device, the movement speed increases, and in the case where the injection nozzle is located in the front end region or the rear end region in the moving direction, the movement speed decreases.

The injection nozzle of the left rotary nozzle means and the injection nozzle of the right rotary nozzle means are arranged so as to be shifted in phase, and preferably, for example, the phases of both are shifted by about 90 degrees from each other.

As a result, when the circular motion of the left injection nozzle is accelerated, the circular motion of the right injection nozzle is decelerated, and when the circular motion of the left injection nozzle is decelerated, the circular motion of the right injection nozzle is accelerated, that is, the reaction force of the acceleration of the movement of the left injection nozzle and the acceleration of the movement of the right injection nozzle are canceled.

In one embodiment of the present invention, the ultra-high pressure water sprayed from the nozzle 91 through the ultra-high pressure water hose (not shown), the rotary joint 95, the narrow hole 924, the nozzle holder 911 and the nozzle bar 912 shoots onto the object surface 1 to remove foreign substances such as old paint film and rust on the object surface. The water is then suctioned and collected by the action of the suction air flow that reaches the decompression generator (not shown) from the decompression space 50 through the connection pipe 10a, suction hose (not shown), and separator such as a bag filter unit (not shown).

While embodiments of the apparatus of the present invention have been described, the apparatus of the present invention is not only on the surface in the atmosphere but also in water. In such a case, a water pump or water-driven ejector is used instead of the vacuum pump.

While the invention has been illustrated by way of example in accordance with embodiments thereof, the present invention is not limited to the embodiments described above, but various modifications or modifications can be made without departing from the scope of the invention.

In equipment equipped with rotating nozzles, such as conventional ultra-high pressure water jet equipment, where the nozzle moves in a circular motion so that the trajectory of the point at which the material injected from the nozzle strikes the surface to be sprayed forms a circular path, the nozzle moves in a constant velocity circular motion. In the present invention, however, the nozzle is configured to perform non-constant circular motion with respect to the motion speed at which the nozzle draws a circular trajectory. More specifically, the present invention is configured so that the motion speed increases when the nozzle is located at the left end or the right end of the device equipped with the rotating nozzle in the moving direction, and decreases when the nozzle is located at the front end or the rear end. This prevents the occurrence of unevenness in processing caused by conventional equipment, and enables uniform quality and efficient surface processing work to be carried out.

According to the present invention, by performing the injection of the substance on the object surface in a reduced pressure space moving along the surface of the object, the foreign matter peeled from the injected substance or the surface of the object can be sucked and recovered by the vacuum generation device, so that the generation source of the atmosphere floating substance can be eliminated and environmental pollution can be prevented.

What is claimed is:

1. An apparatus comprising,
a moving device movable along an object surface; and
a rotary nozzle device configured from a rotary nozzle means mounted on the moving device,
wherein said rotary nozzle means comprises a left rotary nozzle means and a right rotary nozzle means, and the rotary nozzle means comprises a plurality of injection nozzles,
said rotary nozzle means is constituted so that an object to be injected jetted from at least two injection nozzles for performing circular motion is sprayed on a surface to be jetted to draw a circular locus on the surface to be jetted,
said rotary nozzle means is arranged in parallel in a direction orthogonal to the moving direction of the moving device, and the left rotary nozzle means and the right rotary nozzle means are constituted so as to perform rotary motion by interlocking with the rotary conduction means,
when each injection nozzle is located in the left end region or the right end region toward the moving direction of the moving apparatus, the movement speed increases, and when the injection nozzle is located in the front end region or the rear end region in the moving direction, the movement speed is reduced, and
said injection nozzle of the left rotary nozzle means and the injection nozzle of the right rotary nozzle means are provided with a rotary nozzle arranged so that phases are shifted from each other.

2. The apparatus according to claim 1, wherein the rotary nozzle means includes a non-circular gear mechanism as a motion transmission mechanism for converting constant velocity circular motion into unequal velocity circular motion.

3. The apparatus according to claim 1, wherein said moving device includes a box body, a seal defining a pressure reducing space together with the box body and the moving surface, and a pressure reducing generating means for discharging the fluid from the pressure reducing space to reduce the pressure in the pressure reducing space, and
said moving device forms a carriage which is attracted to the moving surface by the pressure of the enclosed fluid and is movable along the moving surface, and the injection nozzle performs a circular motion in the reduced pressure space of the carriage, and the jet nozzle projects the jetted object jetted from the injection nozzle onto the surface to be jetted to draw a circular locus on the surface to be jetted.

4. The apparatus according to claim 1, wherein said rotary conduction means comprises the roller chain, the sprocket, or the gear.

5. The apparatus according to claim 1, wherein said fluid discharged from the pressure reducing space includes a foreign matter peeled from the injected substance or the surface of the object.

6. The apparatus according to claim 1, wherein said apparatus is a device capable of removing foreign matter adhering to the surface of the object by injecting a substance onto the surface of the object or roughening the surface of the object.

7. The apparatus according to claim 1, wherein said apparatus is a device capable of treating or coating the surface of the object by jetting a substance to the surface of the object.
